(19) United States
(12) Patent Application Publication
(10) Pub. No.: US 2014/0054161 A1
(43) Pub. Date: Feb. 27, 2014

(54) VAPOUR ABSORPTION SYSTEM

(71) Applicants: Jayden Harman, San Rafael, CA (US); Francesca Bertone, San Rafael, CA (US); Peter Woodgate, Dianella (AU); Thomas Gielda, Saint Joseph, MI (US)

(72) Inventors: Jayden Harman, San Rafael, CA (US); Francesca Bertone, San Rafael, CA (US); Peter Woodgate, Dianella (AU); Thomas Gielda, Saint Joseph, MI (US)

(21) Appl. No.: 14/115,317

(22) PCT Filed: Apr. 10, 2011
(86) PCT No.: PCT/AU2011/000508

§ 371 Date: Nov. 1, 2013

(30) Foreign Application Priority Data
Apr. 9, 2010 (AU) 2010901506

(51) Int. Cl. B01D 3/10

(52) U.S. Cl. CPC B01D 3/10
USPC 203/42; 202/183; 165/104.25

(57) ABSTRACT

A vapour absorption system (11) adapted to receive a vapour comprising a vacuum pump (16) having an operating liquid wherein the vapour is received by an operating liquid and condensed therein to provide condensed liquid mixed with the operating liquid.

### FIELD OF THE INVENTION

The present invention relates to a system and method for absorption of a vapour into a liquid. The system has many applications but is particularly useful for distillation of a liquid mixture such as water with impurities. It also has application as a heat transfer system. However the system is not limited to these two applications.

Absorption, in chemistry, is a physical or chemical phenomenon or a process in which atoms, molecules, or ions enter some bulk phase by being taken up by the volume. In this application we are particularly concerned about the absorption of a vapour into a liquid.

### BACKGROUND ART

Usual vapour absorption techniques have specific application. They are usually relatively slow process unless some chemical reaction is occurring. Because of this, absorption processes have relatively limited application. However, the present invention has identified a method of obtaining a much faster rate of absorption where chemical interaction is not involved, with the result that vapour absorption systems may be used in applications where they were never previously considered, or at least not considered viable.

Following on from the new vapour absorption system which is disclosed herein, there are disclosed new and improved distillation systems and heat transfer system, making use of the vapour abortion system.

Distillation is of course, a well known process. It is used often where traditional filtration techniques have not been effective at purifying a liquid mixture. Conventional distillation requires the application of heat energy to cause the production of a vapour which is then passed through a condenser to condense the vapour back to a liquid for use. While conventional distillation is generally effective at purifying liquids such as water, the energy cost is substantial and often uneconomic. Improvements to the process have increased efficiency significantly, but the process has remained too expensive for purification of water for general use.

Efforts to improve the efficiency of the distillation process have included attempts at operation at reduced pressure. It is well known that vaporization of liquid occurs more rapidly when the pressure is reduced. However, such systems have had limited success due to difficulty and expense associated with an evacuating system in conjunction with the evaporation and condensing subsystems. An example of one attempt is that disclosed in U.S. Pat. No. 3,864,215 (Arnold). The system of that disclosure utilizes the low pressure region of a venturi to provide the reduced pressure. It was particularly applicable to a marine environment but retained some complexity in that it still incorporated a condenser.

Heat transfer systems are also well known. Air-conditioning and refrigeration systems form subsets of this broad category. It is well known that conventional heat exchange systems use very substantial amounts of energy in order to transfer energy. The use of new vapour absorption systems substantially improves the efficiency or C.O.P. (co-efficient of performance) of a heat transfer system.

### DISCLOSURE OF THE INVENTION

Accordingly, the invention resides in a vapour absorption system adapted to receive a vapour comprising a vacuum pump having an operating liquid wherein the vapour is received by an operating liquid and condensed therein to provide condensed liquid mixed with the operating liquid.

According to a preferred feature of the invention, the absorption of vapour within the system is effective to cause production of more vapour.

According to a preferred feature of the invention, the vacuum pump is a venturi vacuum pump and the operating liquid is a liquid which passes through the venturi vacuum pump to produce a vacuum operative on the vapour.

According to a preferred feature of the invention, a first heat exchange means is provided to support the production of vapour.

According to a preferred feature of the invention, a second heat exchanger is provided to expel heat from the operating liquid after it has passed through the venturi vacuum pump.

According to a preferred feature of the invention, the operating liquid is passed through the first heat exchanger to pass heat from the operating liquid to the first heat exchanger.

According to a preferred feature of the invention, condensed liquid derived from the vapour is removed for use.

According to the preferred embodiment, the system is a distillation system.

According to the preferred embodiment, the system is a heat transfer system.

According to the preferred embodiment, the operating liquid is circulated through the system.

According to a further aspect, he invention resides in a distillation system comprising an evacuation chamber adapted to receive a liquid mixture to be distilled, the evacuation chamber having a space above the liquid mixture filled with a gas, and a vacuum pump associated with the evacuation chamber and adapted in use to provide a reduced pressure within the gas to cause vaporisation of the liquid mixture and wherein a primary liquid is passed in association with the gas in the evacuation chamber to receive and condense the vapour.

According to a preferred feature of the invention, at least a portion of the primary water is circulated through the vacuum pump.

According to a preferred feature of the invention, a first heat exchange means is provided to enable latent heat of vaporization to be received by the liquid mixture to support the vaporization of the liquid mixture.

According to a preferred feature of the invention, the first heat exchange means comprises features associated with the wall of the evacuation chamber to promote the receipt of the latent heat of vaporization from the surroundings.

According to a preferred feature of the invention, the first heat exchange means comprises a first heat exchange means associated with the evacuation chamber through which heat exchange fluid passes to surrender the latent heat of vaporisation to the liquid mixture, the latent heat of vaporisation being received by the heat exchange fluid from a source remote from the first heat exchanger.

According to the preferred embodiment, the vacuum pump is a venturi pump in use having a fluid flow through the venturi pump to provide a reduced pressure at a venturi throat section.

According to the preferred embodiment, the venturi pump has a venturi throat section configured to receive the gas from the evacuation chamber and the fluid flow is the primary liquid so that the venturi pump is operative to cause the reduced pressure of the gas in the evacuation chamber by receiving the gas into the primary liquid.

According to the preferred embodiment, porting is associated with the venturi the pump, the porting being adapted to convey gas to the venturi pump.

According to the preferred embodiment, heat within the primary water exiting the venturi pump is removed by means of a second heat exchange means.

According to the preferred embodiment, the second heat exchange means is associated with a pathway for the primary liquid which passes through ground to surrender heat to the ground.

According to the preferred embodiment, a liquid mixture control system to control the entry and exit of liquid mixture from the evacuation chamber.

According to the preferred embodiment, the liquid mixture to be distilled is water and the primary is a liquid immiscible with water.

According to the preferred embodiment, the primary liquid is oil.

According to a further aspect, the invention resides in a method of distillation of a liquid mixture using an evacuation chamber comprising vaporizing the liquid mixture by reducing the pressure within the evacuation chamber by means of a vacuum pump, to provide a distillation vapour and receiving and condensing the distillation vapour within a primary liquid passing in association with the distillation vapour.

According to a preferred feature of the invention, the vacuum pump is a venturi vacuum pump having a venturi throat section and the primary liquid passes through the venturi vacuum pump to provide a reduced pressure in the venturi throat region and distillation vapour is drawn into the venturi through porting at the venturi throat region and received and condensed by the primary liquid.

According to a preferred feature of the invention, at least a portion of the primary water is circulated.

According to a preferred feature of the invention, at least a portion of the primary water is circulated by being received from a holding tank and being returned to a holding tank after passing through the vacuum pump.

According to a preferred feature of the invention, a first heat exchange means is provided to enable latent heat of vaporization to be received by the liquid mixture to support the vaporization of the liquid mixture.

According to a preferred embodiment, the first heat exchange means comprises features associated with the wall of the evacuation chamber to promote the receipt of the latent heat of vaporization from the surroundings.

According to a preferred embodiment, the first heat exchange means comprises a first heat exchanger associated with the evacuation chamber through which heat exchange fluid passes to surrender the latent heat of vaporisation to the liquid mixture, the latent heat of vaporisation being received by the heat exchange fluid from a source remote from the first heat exchanger.

According to a preferred embodiment, heat within the primary water exiting the venturi pump is removed by means of a second heat exchange means.

According to a preferred embodiment, second heat exchange means is associated with a pathway for the primary liquid which passes through ground or cold water to surrender heat to the ground or cold water, respectively.

According to a preferred embodiment, the primary liquid is oil and the liquid mixture is a mixture of water and other substance or substances.

According to a further aspect, the invention resides in a heat transfer system comprising an evacuation chamber adapted to receive a first liquid, at least one venturi vacuum pump associated with the evacuation chamber to cause, in use, the pressure within the evacuation chamber to be reduced to promote vaporization of liquid in the chamber and to thereby cause cooling, and a first heat exchanger having a fluid pathway for a heat exchange fluid to pass through the first heat exchanger and being associated with the evacuation chamber to provide heat to the first liquid in the chamber to support the vaporization and thereby to cool the heat exchange fluid.

According to a preferred feature of the invention, vapour from the vaporization of the first liquid is received and condensed within a flow stream of a second liquid which passes through the at least one venturi vacuum pump to cause the reduced pressure.

According to a preferred feature of the invention, the flow stream of the second liquid passes through a second heat exchange system after exiting the venturi vacuum to thereby cool the second liquid.

According to a preferred feature of the invention, he second liquid is returned to the inlet of the venturi vacuum pump in cyclic manner.

According to a preferred feature of the invention, the first liquid and the second liquid are of the same substance and evacuation chamber and venturi vacuum pump form a closed system.

The invention will be more fully understood in the light of the following description of several preferred embodiment.

### BRIEF DESCRIPTION OF THE DRAWINGS

The description is made with reference to the accompanying drawings, of which:

FIG. 1 is a diagrammatic representation of a distillation system according to the first embodiment;

FIG. 2 is a diagrammatic representation of a distillation system according to the second embodiment;

FIG. 3 is a diagrammatic representation of a distillation system according to the third embodiment;

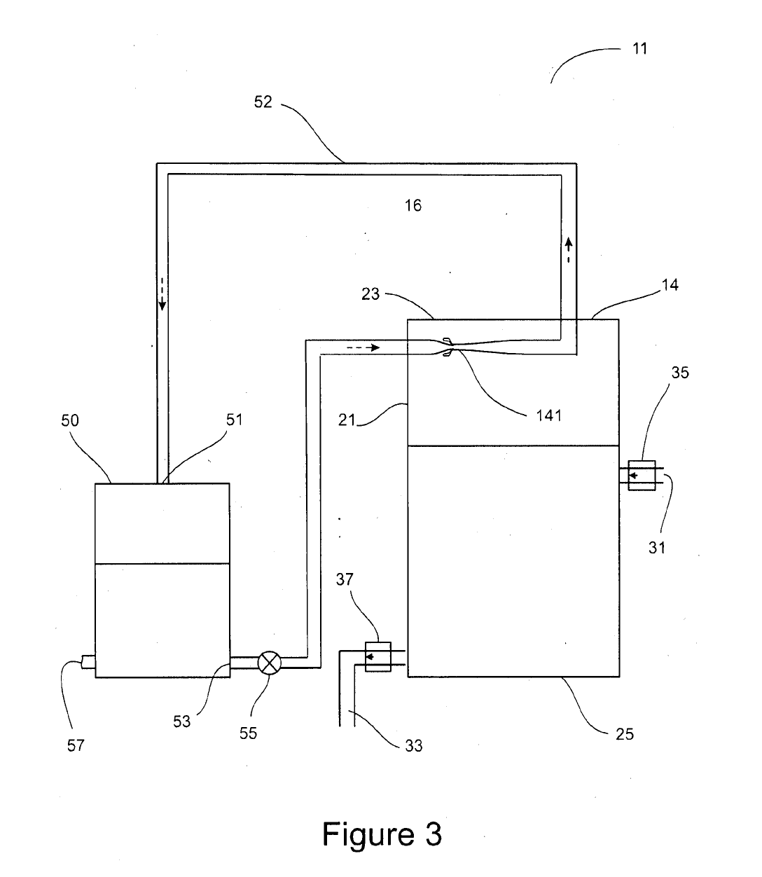

FIG. 4 is a diagrammatic representation of a distillation system according to the fourth embodiment;

FIG. 5 is a diagrammatic representation of a distillation system according to the fifth embodiment; and

FIG. 6 is a diagrammatic representation of a heat exchange system according to the sixth embodiment.

### DETAILED DESCRIPTION OF PREFERRED EMBODIMENTS

The essential element of the vapour absorption systems disclosed herein is a system which places a vapour under a vacuum by use of a vacuum pump having an operating liquid wherein the vapour is received by the operating liquid and condensed therein to provide condensed liquid mixed with the operating liquid. The system therefore is limited to a system whereby the vapour condenses when being absorbed by the operating liquid, rather than an alternative such as being dissolved as a gas. The system is particularly applicable where the system is incorporated in a continuous process and in particular where the absorption of vapour is operative to cause the production of new vapour. The system is most easily provided by use of a venturi vacuum pump and the operating liquid is the liquid which passes through the venturi to produce a vacuum. The venturi thereby produces a vacuum which draws the vapour into the operating liquid, where it condenses. Typical vapours may be water vapour, or methanol. Many others are suitable. In some instances the operating liquid is of the same substance as the vapour. Distillations systems are described below where the operating liquid is water and the vapour is water vapour. In other instances, the operating liquid and the vapour may be different substances. One embodiment described uses oil as the operating liquid and water as the vapour, while another uses water as the operating liquid and methanol as the vapour.

An important aspect of the system is that ongoing vaporization can occur, that is, the process can be continuous. Indeed, the use of the vacuum pump enables the vapour to be replenished because the vapour pressure is reduced as the vapour is absorbed. For a distillation system, the distilled product may be withdrawn from the system for use. In contrast, a heat transfer system is a closed system and nothing (or almost nothing) need be withdrawn or added. Generally, the system will operate on a recycling basis, where the operating liquid recycles through the system. But there are configurations where that need not be the case.

For the vapour absorption system described to be effective, they require a vacuum pump of high efficiency. An improved venturi vacuum pump is disclosed in a corresponding application by the same inventors and based on the same basic application. The rest of this discussion assumes use of a venturi vacuum pump according to that disclosure and therefore that disclosure is hereby incorporated by reference. The features of the vapour absorption system of the invention are best appreciated by a discussion with reference to the specific embodiments.

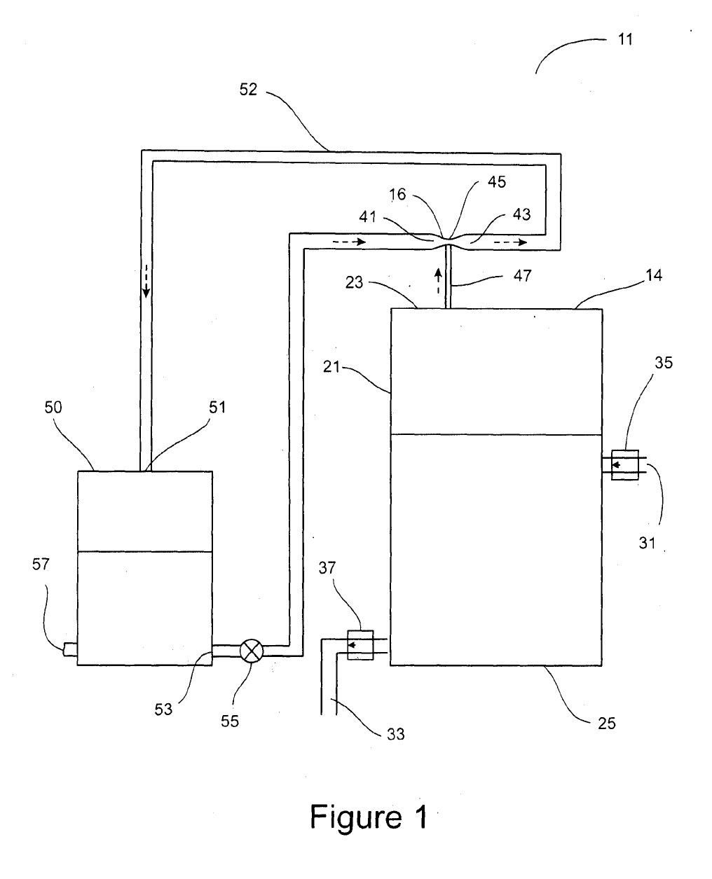

The first embodiment of the invention is directed to a distillation system which incorporates an evacuation chamber and an evacuation pump. The embodiment is described with reference to FIGS. 1.

The distillation system 11 according to the first embodiment comprises an evacuation chamber 14 adapted to receive a quantity of liquid to be distilled. For the purposes of this description, the embodiment will be described with reference to the distillation of water, referred to herein as secondary water, such as contaminated water or ground water which is too polluted or mineralised for direct use, but reference will be made later in the description to the distillation of other mixtures including liquid mixtures. The evacuation chamber 14 is adapted to be evacuated to a reasonably high level (preferably less than 3 kPa) by one or more evacuation pumps 16 and therefore is constructed accordingly. The actual design of the evacuation chamber is not critical to the invention, and will depend significantly upon the circumstances of the installation. Those skilled in the art will be able to identify the appropriate design criteria. Typically, an evacuation chamber may comprise a substantially cylindrical vessel with the axis of the cylinder 21 being oriented substantially vertically. The ends 23, 25 may be strengthened by being of convex or concave profile. But other configurations such as substantially spherical chambers are conceivable.

The evacuation chamber 14 is provided with an inlet 31 and a drain or outlet 33. In the first embodiment, a first valve 35 is associated with the inlet 31 to allow secondary water to enter the chamber upon demand. A second valve 37 is associated with the drain 33 to enable concentrated solution to be flushed from the chamber 14 at the end of a batch process. The evacuation chamber 14 is also provided with access means to enable maintenance of the interior of the chamber 14. The access means may be provided by a removable panel (not shown) or by removal of one of the ends 23 or 25. This access may be used to remove scale and other solid material which may be deposited from the secondary water.

The evacuation pump 16 is arranged to extract vapour from the upper portion of the chamber 14. In the first embodiment, the evacuation pump 16 is a venturi pump, and as is discussed below, a venturi pump is particularly suitable for use in relation to the invention. The venturi pump 40 comprises a venturi inlet 41, a venturi outlet 43 and a narrowed venturi throat section 45 intermediate the venturi inlet 41 and the venturi outlet 43. In the first, embodiment, a port 47 connects the low pressure venturi throat section 45 of the venturi pump 16 with the evacuation chamber 14.

In operation, the venturi pump 16 evacuates the evacuation chamber to a pressure below that of the vapour pressure of the secondary water in the evacuation chamber 14. As a result the secondary water is caused to boil at a relatively low temperature that can be close to normal room temperature. This effect is of course well known and is regularly demonstrated in secondary school science classrooms. In such experiments, the venturi pump is typically connected to a tap or valve of the mains water supply and the water passing through the venturi pump causing the reduced pressure is disposed to waste. In the present invention, it is recognized that the water being expelled from the venturi pump comprises not just the water that enters the venturi inlet 41 but also water from the vapour that is withdrawn from the evacuation tank through the port 47. Such vapour condenses almost immediately upon entering the water stream flowing through the venturi throat section 45. The first embodiment is therefore provided with a receiving tank 50 having a tank inlet 51 connected by piping 52 to the venturi outlet 43. A recirculation outlet 53 is provided proximate the base of the receiving tank 50 which supplies primary water (purified water) to a recirculation pump 55 which pumps primary water to the venturi pump 40. The recirculation pump 55 is selected to be of the size and type suitable to feed the venturi pump 40 at the required pressure and flow rate. A water take off port 57 is provided either as a separate outlet from the receiving tank 50 or as a port from the piping 52 or otherwise to withdraw water from the receiving tank 50 for use. The rate of withdrawal is controlled to prevent the receiving tank from being emptied. To this extent, the receiving tank can act as well as a storage tank or alternatively storage means may be provided separately.

In operation, it can be seen that water is pumped from the receiving tank 50 by the recirculation pump 55 to the venturi pump 16 and then returned to the receiving tank 50. In the process, water is received into the stream from the water vapour extracted from the evacuation tank 14. As is discussed below, it is possible to achieve a take-up rate of about 1 part of water from the evacuation tank to approximately 30 parts of water pumped through the venturi pump 16. The system can therefore be sized according to the volume of water to be withdrawn from the receiving tank 50.

It is to be appreciated that an apparatus according to the first embodiment has removed the need for a conventional condenser system within the distillation system. A condenser system has typically been seen as an essential part of a distillation process but in the first embodiment, the condensation takes place inherently in the venturi pump 16. This has significant advantages which are discussed later.

While the distillation system described does not require the secondary water to be raised to a high temperature, it is to be appreciated that the boiling process nonetheless requires the input of heat energy to provide the latent heat of vaporisation. The advantage of the system is that while the energy must be provided, because the evaporation system can be arranged to operate at or near an ambient or normal temperature, a low grade heat source may be used. For small units, the evacuation tank 14 may be configured to withdraw sufficient energy from the atmosphere. In the first embodiment, the cylindrical wall of the evacuation chamber 14 has a corrugated profile to increase the surface area and thereby facilitate the removal of heat from the atmosphere. In a further adaptation, the external surface of the evacuation chamber is painted black to promote the absorption of heat from the external environment.

The temperature required in the secondary water depends significantly upon the performance of the vacuum pump and in particular the vacuum level achieved. At the same time, it is to be appreciated that as the pressure, is reduced a greater volume of vapour will be caused to boil off. In addition, it has been found by testing and modelling that good performance of the venturi system requires that the there be a significant, difference between the temperature of primary water and the secondary water. The primary water should be at least 15° C. cooler than the secondary water. Preferably, the primary water should be cooler than the secondary water by 20° C. or more.

It is desirable that the temperature of the secondary water is in the vicinity of at least 40° C. or more and therefore, this embodiment can be suitable for a situation where the surroundings can provide the latent heat energy from the surroundings.

In some locations, secondary water is available that is already at or above the desired operating temperature of the secondary water. In these circumstances, the latent heat may be provided simply by having a controlled, continuous flow of secondary water through the evacuation chamber at a rate somewhat above the rate of evaporation of vapour. This arrangement has the added advantage that the level of concentration of the salts in the secondary chamber is kept at a stable level which is not substantially higher than that of the incoming secondary water. This will significantly reduce the build up of salt deposits in the evacuation chamber and therefore reduce the maintenance requirements of the chamber. For this latter reason, continuous flow of the secondary water will be preferred even where the secondary water is too cool, and additional heating must be added, as in the second embodiment. In a sophisticated adaptation, a feedback control system is incorporated to regulate the flow of secondary water through the evacuation chamber to control the temperature and/or the salt concentration to desired levels.

It will also be appreciated that the latent heat energy contained within the water vapour will be added to the water flowing through the venturi pump 16 at the time the water vapour condenses into the flow stream. As discussed below, it is desirable that the temperature of the primary water flowing into the venturi is significantly below that of the secondary water, and in the embodiment, the temperature is kept around 12° C. In the first embodiment, this heat energy is transferred to the receiving tank where it is dispersed to the environment. If the receiving tank also serves as a storage tank with a relatively large volume, the temperature rise will be minor and easily dispersed. There are many locations where this means of disposing of the heat will be suitable. In other locations, it is practicable to disperse the heat into the ground by passing outlet pipes through the ground before the water is passed to storage. Other means of cooling will be apparent to those skilled in the art where appropriate circumstances apply.

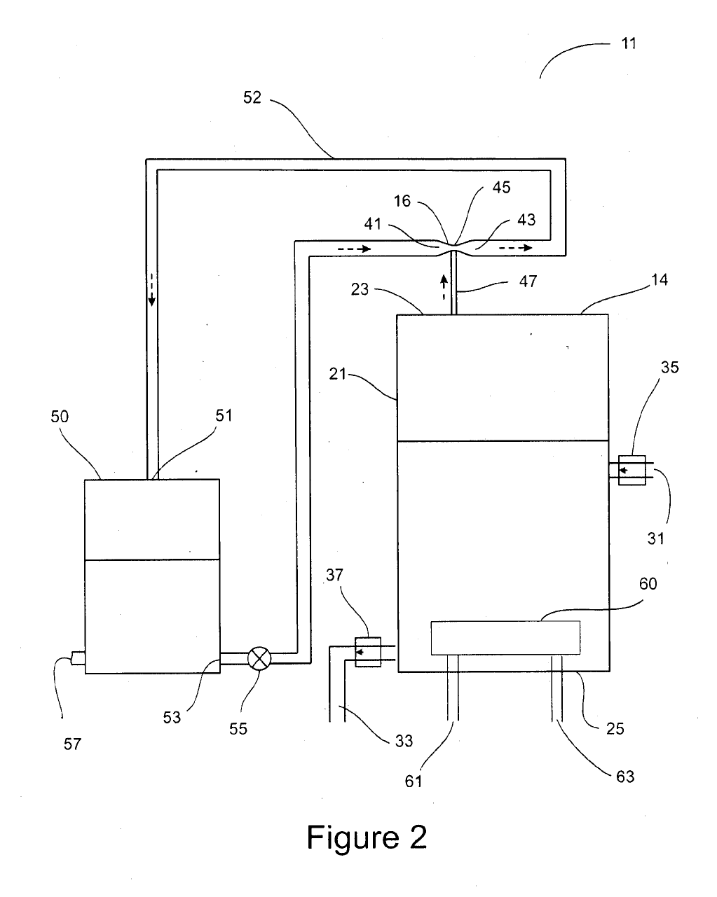

A second embodiment takes cognisance of the energy flow that is required and is adapted to facilitate those flows. The second embodiment is described with reference to FIG. 2. The second embodiment is substantially identical to the first embodiment, and therefore, in the drawings, like features are denoted with like numerals.

The second embodiment differs from the first embodiment by the inclusion of a evaporation heat exchanger 60 positioned to be within the secondary water in the evaporation chamber 14, or otherwise associated with the evaporation chamber 14 to allow heat flow from the evaporation heat exchanger 60 to the secondary water. The evaporation heat exchanger 60 is provided with an exchanger inlet 61 and an exchanger outlet 63. The exchanger inlet 61 is supplied with exchanger fluid from a low grade heat source. Examples of suitable heat sources are a solar heated pond, or water heated from a geothermal source. The exchanger fluid exits through the exchanger outlet 63 and returned to the heat source for reheating. The rate of flow may be maintained to control the heat input to the secondary water, or alternatively, the heat input to the exchange fluid may be controlled at the heat source.

It is to be appreciated that the effectiveness of the distillation system according to the embodiments depends upon the effectiveness of the venturi in reducing pressure and drawing vapour away. A conventional venturi is not efficient and therefore venturi vacuum pumps are generally in use for other purposes with limited application and only where efficiency is not of primary concern. It would not be cost effective for the present applications. However, an improved venturi is disclosed in a co-pending application claiming priority from the same application as this application. The performance of this new venturi is a substantial improvement over the performance of a conventional venturi rendering the present invention economically viable.

Certain embodiments of the improved venturi comprise a chamber having an inlet tube, an outlet tube and a vacuum port. Such units therefore can be readily used in the first and second embodiments. Other embodiments of the improved venturi do not have a chamber and draw the gas or vapour directly from its surroundings. Therefore a third embodiment of a distillation system is disclosed which is adapted to incorporate a venturi as described. The third embodiment is described with reference to FIG. 9. The third embodiment is substantially similar to the first embodiment and so, in the drawings, like numerals are used to denote like features.

The difference between the third embodiment and the first embodiment is that the venturi is placed inside the evacuation chamber 14 proximate the upper end 23, rather than being outside the evacuation chamber 14 and connected to the evacuation chamber by port 47. In other respects the third embodiment is identical to that of the first embodiment and will not be described further.

In a further adaptation of the third embodiment, a filtration means is provided at the vapour entry into the venturi to remove any liquid droplets and return them to the secondary water, thereby avoiding contamination of the primary water. This water is not returned to the venturi and therefore the heat rise due to release of latent heat upon the absorption and condensation of the vapour does not affect the operation of the

While development of the improved vacuum pumps is in its infancy and many parameters of the configuration will vary the performance, it is believed that there may be a maximum optimal size for larger applications. If that is so, it is possible to operate a plurality of venturis in parallel to remove a higher volume of vapour. The invention is therefore scalable from small domestic units to large systems suitable for reticulated supplies of cities.

It will be appreciated that the second embodiment may be modified in a manner similar to the adaptation of the third embodiment.

In an adaptation of the first, second or third embodiments, where a continuous stream of cold water is available, this stream can be fed directly to the venturi as the primary water. This may be the case for a supply of water for a town or city. Water being supplied to consumers may be broken into several smaller streams and passed through a plurality of venturi vacuum pumps associated with one or more evacuation chambers. While the condensation/absorption process will heat the water as discussed, this will not usually be a problem, particularly in cold environments where it may even be an advantage. In such installations the water is often gravity fed, which removes the need for a pump to pressurize the primary water entering the venturi. If a low cost energy source is available to provide the latent heat, the operating cost will be very low. The capital cost will also be modest. Without recirculation, the amount of water collected will only be small, around 5% to 8% of the primary water presented, but there are many water authorities that would pleased to obtain that level of increase in useable water at relatively very low operating and capital cost. Of course the productivity may be increased by introducing some recirculation. This could be achieved by having a holding pond above the elevation of the distillation system from which the primary water is supplied and a certain proportion of the flow can be pumped into the holding pond. This would all a water authority considerable flexibility. When rain water is plentiful, no recirculation is required and a percentage increase in supply is provided at minimal operating cost. When supply is moderate, still adequate but less than needed to keep the storage systems full, some recirculation can be provided to maintain the storage system close to capacity. As rainfall supply becomes low, so the storage supply is being drained, recirculation can be increased to a more significant level to slow the fall of storage levels but not to stop it. If a drought occurs and storage levels become critical, recirculation can be increased so that the distillation system provides almost the full demand. Even where low-grade energy is only available to a limited extent, the distillation cost will still be competitive with alternative drought relief measures. It is worth noting that in many places, times of drought risk coincide with time of high solar energy availability (summer), so with an appropriate designed solar energy system, modest energy cost will be available. In a normal year, additional costs for pumping may be easily amortised and offset against the times no pumping is required to maintain a very economic water supply.

It can be seen that a distillation system according to the embodiments described so far wherein a vacuum pump reduces the pressure in an evacuation chamber causing secondary water therein to boil and wherein the water vapour resulting is received directly into primary water associated with the vacuum pump has advantages. Due to direct removal of the water vapour into primary water, no separate condensation unit is required. As well, the boiling occurs at a temperature that is considerably lower than at normal pressure, which means that the hazards are reduced significantly. Also, as previously discussed, the heat required can be provided from a low grade source at considerably reduced expense. Especially for larger installations, the capital cost as well as the maintenance and running costs will be considerably reduced over those of competing technologies.

While the application has been discussed with respect to water containing contaminants, pollution of dissolved salts, or to mixtures such as water and heavy metals or water and sewerage, the systems described can be readily adapted to a much wider range of mixtures including mixtures of liquids. Its use for the distillation of ethanol from an ethanol water mixture is most advantageous. Typically, when ethanol is obtained from crops such as tapioca or corn, the processing results in a liquid mixture that contains approximately 20% alcohol to 80% water. Conventionally, this mixture is distilled at high temperature in a process that requires considerable high grade energy and this affects the cost of production. However, use of the distillation process as described herein enables the high grade energy to be replaced by low grade energy. In addition, the distillation process works in reverse from the normal distillation process described for sea water. Because the ethanol-water mixture is an azeotrope, the secondary mixture in the evacuation chamber which starts at about 20% alcohol will be concentrated by the distillation process towards the azeotropic concentration of approximately 96% ethanol. The evacuation boiling process results in a certain amount of the ethanol being evaporated as well as the water. This evaporated ethanol is taken up by the primary water in the venturi and therefore is not lost. While the ethanol concentration in the primary water will be relatively low, the primary water can then be utilized at an earlier stage of the production process so that the ethanol will once again end up being distilled. Thus there is no loss of product but a substantial reduction in energy costs is achieved. Where, alcohol is required at a higher level of purity than the azeotropic concentration, existing production techniques can be used or adapted to raise the concentration further. It will be appreciated that there are many other distillation processes that can benefit from the application of the embodiments to those processes.

The process so far has been described with reference to distillation, but as mentioned before the vapour absorption process has an effect that has other applications. In order to provide a better understanding of the invention, a summary of the principles of operation are given below.

1. The salt water in the tank H1 is boiled off at extremely low pressure. The low pressure is generated via the venturi effect from the fresh water flow through the venturi C2. Pressures less than 3 kPa are desirable and have been generated in testing. This will allow the water to boil off at temperatures between 30-65° C.

2. As the water boils away from the salt water mixture energy must be added to the system. Note if water is vaporised at a rate of 1 ml/sec, 2.4 kW of power must be supplied to provide the latent heat. Any available heat source may be used but low cost power such as solar power or waste heat is preferred.

3. The process is enabled by the low pressures generated by the fresh water flow because of the efficient design of the venturis used. The pressure within the evaporation tank H1 can reach below 3 kPa. In addition, the fresh water flow should be cool at approximately 10-20° C. The temperature differential is key to sustaining the boiling process. A temperature differential of at least 20° C. and preferably higher is desirable. If the temperature of the fresh water flow stream approaches the temperature of salt water in the tank, the fresh water flow cavitates, greatly reducing the efficiency of the cycle.

4. Fresh water vapour is entrained into the fresh water flow at the venturi. Since the fresh water flow is much colder than the water vapour, the water vapour immediately goes back into solution, releasing significant heat.

5. The fresh water stream at C3 is now significantly warmer than and must be cooled. This may be accomplished by any appropriate means available at the location, such as pumping the water underground.

6. Since the cycle boils the salt water at much lower temperature, a heat source of lower quality (temperature) may be used. It is believed that solar energy may be used in many locations to maintain the temperature of the salt water in the vicinity of 50° C.

7. Since we are using a lower quality heat source, the energy input into the system from man-made sources is greatly reduced, thereby increasing the efficiency of the system.

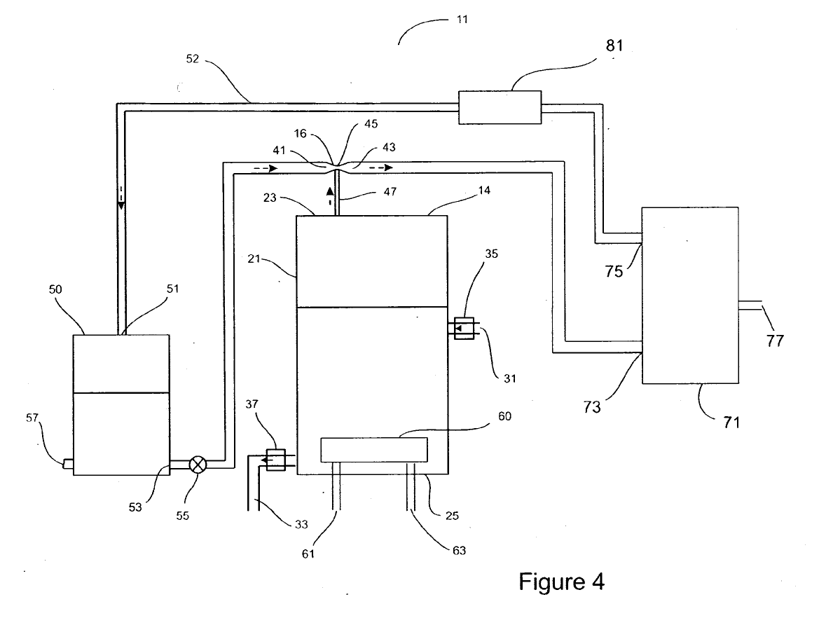

The requirement to have the primary water entering the venturi vacuum to be at a temperature significantly lower than the water in the evacuation chamber provides a significant limitation to the system in certain applications. However, it has been found that the primary liquid can be vegetable or other oil or other immiscible chemicals or an oil-water mix. In this case the oil can be at ambient temperature and does not need to be cooled to a temperature below that of the sea water mixture in the evaporation chamber. Therefore, a fourth embodiment is described with reference to FIG. 4 which benefits from this advantage. The fourth embodiment is similar to the second embodiment and so, in the drawings like numerals are used to depict like features.

The significant difference between the fourth embodiment and the second embodiment, and indeed the first embodiment also, is that an oil is used as the primary liquid which is passed through the venturi vacuum pump 16 rather than water. As the oil travels through the venturi vacuum pump 16 it reduces pressure in the salt water mixture in the evaporation chamber 14, and causes the reservoir water to boil and vaporize in the manner as previously disclosed with reference to the first and second embodiments. Instead of being recycled directly, the resulting primary mixture of oil and condensed water is passed to a separator inlet 73 of separation means 71. The separation means 71 may take the form of a settling tank or a cyclone or other device adapted to separate the secondary water and oil. The oil is removed from the settling means 71 at oil outlet 75 and recirculated while the distilled water is drawn off from water outlet 77. The primary mixture of oil and condensed water is still heated from the latent heat when the water condenses, but it is no longer essential to drop the temperature below that of the water mixture in the evacuation tank. Therefore a conventional heat exchanger 81 is provided which can remove the heat of the heated oil to ambient surroundings, lowering the temperature to only a little above ambient. With oil, the venturi will still perform satisfactorily at this temperature. After leaving the heat exchanger 51 the oil is either returned to receiving tank 50 or indeed may be returned directly to the inlet of the venturi vacuum pump. If used, the receiving tank 50 may only be a holding tank with no cooling function at all, although in certain applications further cooling may still be desirable.

It can be seen that the use of oil or the like expands the applications of the invention.

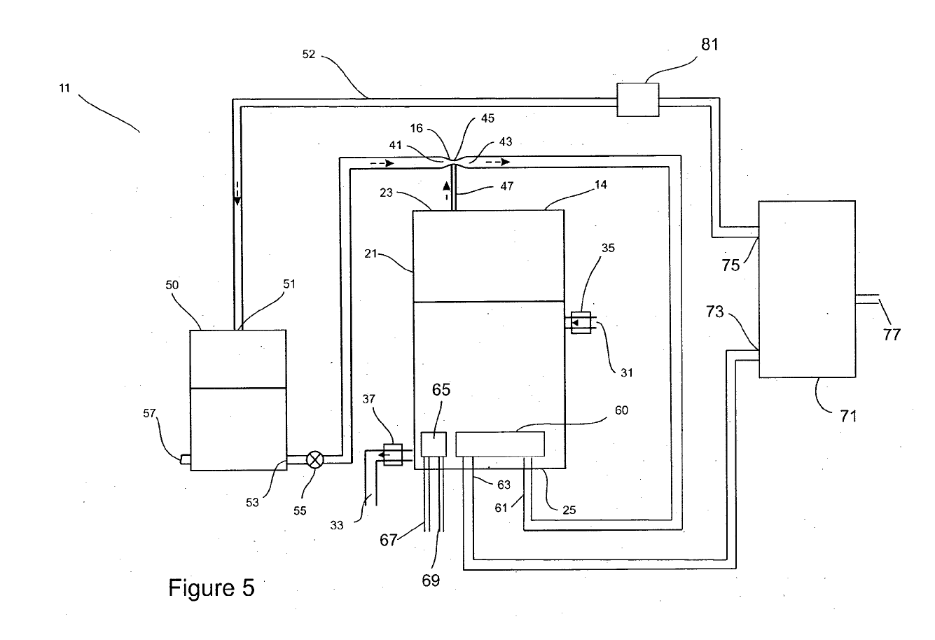

The use of oil or similar as the primary liquid as in the fourth embodiment allows a further adaptation which has a major impact of the viability of the distillation system of the invention for many applications. A fifth embodiment now describes that adaptation with reference to FIG. 5. The fifth embodiment is very similar to the fourth embodiment, and so, in the drawings, like numerals are used to depict like features.

The fifth embodiment differs from the fourth embodiment by routing the primary mixture of oil and condensed water which exits from the venturi vacuum pump 16 to the inlet 61 of the evaporation heat exchanger 60 associated with the evaporation chamber 14. When the fluid exits from the evaporation heat exchanger 60 at outlet 62 it passes to the separation means 71 where the water and oil are separated, as in the fourth embodiment.

The advantage of the fifth embodiment is that a substantial portion of the latent heat required for vaporization in the evacuation chamber is supplied by the latent heat returned to the oil/water mixture when the water condenses. Fundamentally, the latent heat required for vaporization is equal to the latent heat returned to oil/water mixture when the vapour condenses. The effectiveness will depend upon the extent to which the latent heat can be extracted by the evaporation heat exchanger 60. With a high efficiency heat exchanger, a small temperature difference can sustain extraction of a substantial percentage of the latent heat.

It is not possible to extract all energy from the oil/water mixture and therefore a supplementary heat exchanger 65 having an inlet 67 and an outlet 69 is provided to receive energy from a suitable source to provide the additional energy not taken from the evaporation heat exchanger. However, with appropriate selection of an oil and an appropriate design of the venturi vacuum pump the percentage of energy required to be provided by the secondary heat exchanger 65 will be relatively small, so that the overall efficiency of the system is high. In operation, the equilibrium of the system can be controlled by the extent of energy input from the supplementary heat exchanger 65. This can be controlled by adjusting the temperature of the fluid passing through the supplementary heat exchanger 65 as well as the flow rate of that fluid. Crucially, the effectiveness of system will depend upon the extent that the performance of the venturi will be maintained where the temperature of the primary liquid is above the temperature of the liquid being evaporated. With the first three embodiments, the performance deteriorates drastically so that operation of the system collapses. But as discussed, where oil is used the venturi performance continues. Choice of primary liquid will therefore be an important criteria when the system is used for the distillation of other liquids.

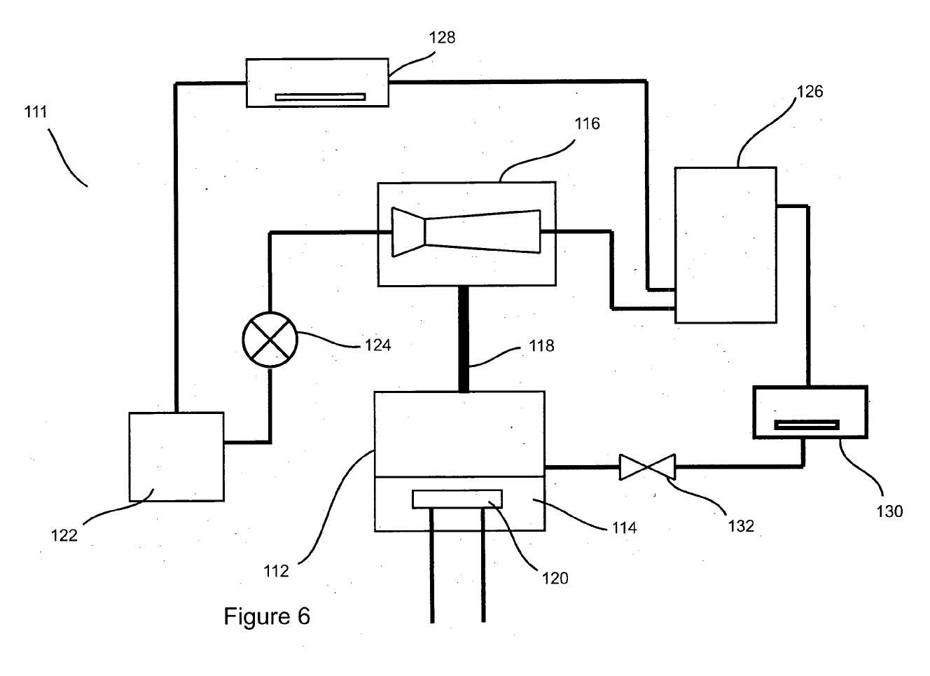

Up until this point of the description, a system has been described wherein a liquid is distilled by generating a substantial vacuum. To support the process, except for the fifth embodiment, significant amounts of energy must be transferred into the liquid to be distilled in order to supply the latent heat of vaporization. Providing this heat at reasonable cost is a key factor to the commercial viability of the distillations systems that have been described. But, of course, the transfer of heat is frequently an object in its own right. It is the basis of all air conditioning and refrigeration systems. Therefore a sixth embodiment of the invention is described. This system is used as a heat transfer system although it is only a minor adaptation of the fourth embodiment. The embodiment of the heat transfer system is now described with reference to FIG. 6 and the distillation system of the second embodiment. As shown in FIG. 6, the heat transfer system 111 comprises an evacuation chamber 112 adapted to hold a body of a refrigerating liquid 114. One or more high performance venturi vacuum pumps 116 are associated with the chamber 112 by connection means 118 to reduce the pressure within the evacuation chamber 112 to cause boiling of the refrigerating liquid 114 and thereby vaporization. The vapour derived is drawn off by the venturi vacuum pump through the connection means 118 in a manner similar to that of the embodiments of the distillation system previously described. As in the second embodiment of the distillation system, a first heat exchanger 120 is associated with the evacuation chamber 112 to provide relatively warm fluid to the heat exchanger 120 to supply the heat which is surrendered to the refrigerating liquid 114 to provide the latent heat of vaporization. In the process, the heat exchange fluid is cooled and this cooled fluid can be circulated to a remote heat exchanger, for air conditioning, refrigeration or the like.

While the principle of operation is the same as for the distillation system, certain details differ because the object is not to draw off a purified liquid but to transfer heat. The system is therefore configured to recycle the liquid that is evaporated back to the evaporation chamber. The liquid in the evaporation chamber is therefore a refrigerant and certain co-fluids have been found to be particularly suitable, amongst them, acetone/water, methanol/water and linoleic acid/methanol. For the remainder of the discussion of this embodiment, the use of water/methanol will be discussed. In that case, the refrigerating liquid is methanol and the primary liquid is water. Optionally, a supply of water is stored in container 122. Water from the container 122 is pumped by pump 124 at a relatively low pressure in the order of 200 kPa to the venturi vacuum pump 116. The reduced pressure generated by the venturi as the primary water flows through it causes methanol in the evaporation container to boil and the vapour to be conveyed to the venturi where it is absorbed into the primary water and condenses to liquid almost instantaneously. Again, latent heat is released into the water/methanol mixture causing the temperature of the mixture to rise. The water/methanol mixture exits the venturi and is conveyed to a separating means 126. At the separating means 126, the methanol is separated from the water and then drawn off. At this time, the water and methanol are at raised temperature. After being removed from the separating means 126, water is passed to a primary loop heat exchanger 128 to release heat to the environment. As the temperature of the water does not need to be reduced below ambient, a simple heat exchanger will suffice. As well, the methanol is heated and preferably this also passes through a methanol heat exchanger 130 before being returned to the evaporation chamber 112. As an alternative to the provision of a primary loop heat exchanger and a methanol heat exchanger, a single heat exchanger may be provided before the separating means to cool the water/methanol mixture. While this arrangement is preferable because of the use of a single heat exchanger, it may introduce problems with certain fluid mixtures. In either case, there will be applications where the heat energy is used for heating purposes by appropriate use of the heat exchanger. A valve means 132 between the methanol heat exchanger and the evaporation chamber 112 (or separating means 126 and evaporation chamber 112 if there is no methanol heat exchanger) controls the return of methanol to the evaporation chamber 112.

Just as with existing heat transfer systems the many adaptations are possible, so it is with the present embodiment. The lessons of existing heat exchange systems will remain applicable to the present embodiment. In certain adaptations, a primary liquid and secondary liquid are of the same substance and evacuation chamber and venturi vacuum pump form a closed system.

A heat transfer system comprising an evacuation chamber adapted to receive a first liquid, at least one venturi vacuum pump associated with the evacuation chamber to cause, in use, the pressure within the evacuation chamber to be reduced to promote vaporization of liquid in the chamber, and a first heat exchanger having a fluid pathway for a heat exchange fluid to pass through the first heat exchanger and being associated with the evacuation chamber to provide heat to the first liquid in the chamber to support the vaporization and thereby to cool the heat exchange fluid.

It will be recognized that many modification and adaptations may be made to the embodiments described while remaining within the scope of the invention. It is to be understood that all such modifications and adaptations are to be considered as being within the scope of the inventions described.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

1. A vapour absorption system adapted to receive a vapour comprising a vacuum pump having an operating liquid wherein the vapour is received by an operating liquid and condensed therein to provide condensed liquid mixed with the operating liquid.

2. A vapour absorption system as claimed in claim 1 wherein the absorption of vapour within the system is effective to cause production of more vapour.

3. A vapour absorption system as claimed in claim 2 wherein the vacuum pump is a venturi vacuum pump and the operating liquid is a liquid which passes through the venturi vacuum pump to produce a vacuum operative on the vapour.

4. A vapour absorption system as claimed in claim 3 wherein a first heat exchange means is provided to support the production of vapour.

5. A vapour absorption system as claimed in claim 4 wherein a second heat exchanger is provided to expel heat from the operating liquid after it has passed through the venturi vacuum pump.

6. A vapour absorption system as claimed in claim 4 wherein the operating liquid is passed through the first heat exchanger to pass heat from the operating liquid to the first heat exchanger.

7. A vapour absorption system as claimed in any one of claims 4 to 6 wherein condensed liquid derived from the vapour is removed for use.

8. A vapour absorption system as claimed in claim 7 wherein the system is a distillation system.

9. A vapour absorption system as claimed in claim 4 or claim 5 wherein the system is a heat transfer system.

10. A vapour absorption system as claimed in any one of claims 1 to 9 wherein the operating liquid is circulated through the system.

11. A distillation system comprising an evacuation chamber adapted to receive a liquid mixture to be distilled, the evacuation chamber having a space above the liquid mixture filled with a gas, and a vacuum pump associated with the evacuation chamber and adapted in use to provide a reduced pressure within the gas to cause vaporisation of the liquid mixture and wherein a primary liquid is passed in association with the gas in the evacuation chamber to receive and condense the vapour.

12. A distillation system as claimed in claim 11 wherein at least a portion of the primary water is circulated through the vacuum pump.

13. A distillation system as claimed in either of claim 11 or 12 wherein a first heat exchange means is provided to enable latent heat of vaporization to be received by the liquid mixture to support the vaporization of the liquid mixture.

14. A distillation system as claimed in claim 13 wherein the first heat exchange means comprises features associated with the wall of the evacuation chamber to promote the receipt of the latent heat of vaporization from the surroundings.

15. A distillation system as claimed in claim 14 wherein the first heat exchange means comprises a first heat exchange means associated with the evacuation chamber through which heat exchange fluid passes to surrender the latent heat of vaporisation to the liquid mixture, the latent heat of vaporisation being received by the heat exchange fluid from a source remote from the first heat exchanger.

16. A distillation system as claimed in any one of claims 11 to 15 wherein the vacuum pump is a venturi pump in use having a fluid flow through the venturi pump to provide a reduced pressure at a venturi throat section.

17. A distillation system as claimed in claim 16 wherein the venturi pump has a venturi throat section configured to receive the gas from the evacuation chamber and the fluid flow is the primary liquid so that the venturi pump is operative to cause the reduced pressure of the gas in the evacuation chamber by receiving the gas into the primary liquid.

18. A distillation system as claimed in claim 17 wherein porting is associated with the venturi the pump, the porting being adapted to convey gas to the venturi pump.

19. A distillation system as claimed in any one of claims 16 to 18 wherein heat within the primary water exiting the venturi pump is removed by means of a second heat exchange means.

20. A distillation system as claimed in, claim 19 wherein the second heat exchange means is associated with a pathway for the primary liquid which passes through ground to surrender heat to the ground.

21. A distillation system as claimed in any one of claims 11 to 20 which further comprises a liquid mixture control system to control the entry and exit of liquid mixture from the evacuation chamber.

22. A distillation system as claimed in any one of claims 11 to 21 wherein the liquid mixture to be distilled is water and the primary is a liquid immiscible with water.

23. A distillation system as claimed in claim 22 wherein the primary liquid is oil.

24. A method of distillation of a liquid mixture using an evacuation chamber comprising vaporizing the liquid mixture by reducing the pressure within the evacuation chamber by means of a vacuum pump, to provide a distillation vapour and receiving and condensing the distillation vapour within a primary liquid passing in association with the distillation vapour.

25. A method of distillation as claimed in claim 24 wherein the vacuum pump is a venturi vacuum pump having a venturi throat section and the primary liquid passes through the venturi vacuum pump to provide a reduced pressure in the venturi throat region and distillation vapour is drawn into the venturi through porting at the venturi throat region and received and condensed by the primary liquid.

26. A method of distillation as claimed in claim 24 or 25 wherein at least a portion of the primary water is circulated.

27. A method of distillation as claimed in claim 24 wherein at least a portion of the primary water is circulated by being received from a holding tank and being returned to a holding tank after passing through the vacuum pump.

28. A method of distillation as claimed in any one of claims 24 to 27 wherein a first heat exchange means is provided to enable latent heat of vaporization to be received by the liquid mixture to. support the vaporization of the liquid mixture.

29. A method of distillation as claimed in claim 28 wherein the first heat exchange means comprises features associated with the wall of the evacuation chamber to promote the receipt of the latent heat of vaporization from the surroundings.

30. A method of distillation as claimed in claim 29 wherein the first heat exchange means comprises a first heat exchanger associated with the evacuation chamber through which heat exchange fluid passes to surrender the latent heat of vaporisation to the liquid mixture, the latent heat of vaporisation being received by the heat exchange fluid from a source remote from the first heat exchanger.

31. A method of distillation as claimed in any one of claims 28 to 30 wherein heat within the primary water exiting the venturi pump is removed by means of a second heat exchange means.

32. A method of distillation as claimed in claim 31 wherein second heat exchange means is associated with a pathway for the primary liquid which passes through ground or cold water to surrender heat to the ground or cold water, respectively.

33. A method of distillation as claimed in any one of claims 24 to 32 wherein the primary liquid is oil and the liquid mixture is a mixture of water and other substance or substances.

34. A heat transfer system comprising an evacuation chamber adapted to receive a first liquid, at least one venturi vacuum pump associated with the evacuation chamber to cause, in use, the pressure within the evacuation chamber to be reduced to promote vaporization of liquid in the chamber and to thereby cause cooling, and a first heat exchanger having a fluid pathway for a heat exchange fluid to pass through the first heat exchanger and being associated with the evacuation chamber to provide heat to the first liquid in the chamber to support the vaporization and thereby to cool the heat exchange fluid.

35. A heat transfer system as claimed at claim 34 wherein vapour from the vaporization of the first liquid is received and condensed within a flow stream of a second liquid which passes through the at least one venturi vacuum pump to cause the reduced pressure.

36. A heat transfer system as claimed in claim 35 wherein the flow stream of the second liquid passes through a second heat exchange system after exiting the venturi vacuum to thereby cool the second liquid.

37. A heat transfer system as claimed in claim 36 wherein the second liquid is returned to the inlet of the venturi vacuum pump in cyclic manner.

38. A. heat transfer system as claimed in claim 37 wherein the first liquid and the second liquid are of the same substance and evacuation chamber and venturi vacuum pump form a closed system.
